(19) United States
(12) Patent Application Publication
(10) Pub. No.: US 2005/0028598 A1
(43) Pub. Date: Feb. 10, 2005

(54) Pressure sensor for contactless pressure measurement, micromechanical pressure switch, and micromechanical pressure change sensor

(76) Inventor: Heinz-Georg Vossenberg, Pfullingen (DE)

Correspondence Address: KENYON & KENYON, ONE BROADWAY, NEW YORK, NY, 10004, US

(21) Appl. No.: 10/802,521

(22) Filed: Mar. 17, 2004

(30) Foreign Application Priority Data
Mar. 18, 2003 (DE) 103 11 795.4

(51) Int. Cl. B60C 23/02

(52) U.S. Cl. 73/715

(57) ABSTRACT

A pressure sensor for contactless pressure measurement, in particular of gas pressures, having a pressure switch which is switched on or off as a function of the prevailing pressure. An in particular robust and long-lasting pressure sensor may be implemented when an LC circuit connected to the pressure switch is provided which is opened or closed as a function of the prevailing pressure.

### FIELD OF THE INVENTION

The present invention relates to a pressure sensor and sensor system for measuring gas pressures which is connected to an evaluation unit in a contactless manner. The present invention further relates to a micromechanical pressure switch produced from a semiconductor substrate, and to a method for producing such a micromechanical pressure switch. The present invention further relates to a micromechanical pressure change sensor for measuring a change in pressure.

### BACKGROUND INFORMATION

Pressure sensors for measuring gas pressures are required in numerous applications. One example from the related art is the measurement of the tire pressure in a motor vehicle. Such a measuring system includes one or more pressure sensors which, together with an electronic evaluation unit and a transmitter, are situated in the interior of a motor vehicle tire. The sensor signals are evaluated using an electronic evaluation unit and are then transmitted in the form of high-frequency (HF) signals to a stationarily mounted receiver. The transmission process requires a relatively large amount of power. To ensure the HF transmission of data, an energy storage unit (battery) is provided in the wheel, and must be replaced when its service life has ended. This system is therefore very costly and complex.

### SUMMARY

It is an object of the present invention to provide a pressure sensor or a pressure sensor system for contactless pressure measurement which requires no local power source (battery) for transmitting the measured data to a receiver. Another object of the present invention is to provide a micromechanical pressure switch and a micromechanical pressure change sensor which may be used in particular for tire pressure measurement owing to their size, robustness, and precision.

In accordance with example embodiments of the present invention, a pressure sensor is provided having a pressure switch which is connected to a resonant circuit, for example an LC circuit (electrical oscillating circuit). The resonant circuit, preferably a serial oscillating circuit, is opened or closed by the switch as a function of the prevailing pressure. The closed state may be detected by an externally situated evaluation unit.

For carrying out a pressure measurement, the pressure sensor is excited by an external transmitter which is able to emit frequencies in the range of the resonant frequency of the resonant circuit. The transmitter includes an electronic evaluation unit which is able to evaluate the degree of absorption and/or the resonant response of the resonant circuit. The evaluation according to the principle of absorption is based on the fact that the resonant circuit absorbs significantly more energy upon excitation at its resonant frequency than at other frequencies. This may be set at the transmitter. The evaluation according to the principle of the resonant response is based on the fact that when the resonant circuit is in resonance, it emits harmonic waves at higher frequencies which the electronic evaluation unit in the transmitter is able to detect. An evaluation of the harmonic waves (according to frequency and/or amplitude) increases the reliability of the measurement and reduces the sensitivity to interference.

One advantage of a pressure sensor according to the present invention or a pressure sensor measuring system according to the present invention is that the pressure sensor is excited in a purely passive manner and does not require its own power supply such as a battery, for example. The pressure sensor according to the present invention may therefore be manufactured in a particularly compact, simple, and economical manner, and furthermore has a virtually unlimited service life.

The pressure switch for the pressure sensor has a predetermined pressure threshold at which the pressure switch switches on, for example, when the threshold is exceeded and switches off, for example, when the value drops below the threshold. Thus, when a single pressure sensor is used it can only be determined whether the prevailing pressure is higher or lower than the predetermined threshold. To improve the approach, it is proposed that multiple pressure sensors whose pressure switches have different switching thresholds and whose resonant circuits have different resonant frequencies be provided in the measuring system.

The interference resistance of such a system may be significantly improved if at least two pressure sensors are used whose pressure switches have the same or generally the same switching thresholds, but whose resonant circuits have different resonant frequencies. A plausibility test is thus possible, whereby the influence of interfering frequencies may be eliminated. In this case, a pressure measurement results in two absorption maxima at these resonant frequencies. An interference frequency from the outside environment which is present in the region of only one of the resonant frequencies is therefore not able to negatively influence the measurement results.

A micromechanical pressure switch according to the present invention is produced from a semiconductor substrate, and preferably has a recess provided in the semiconductor substrate in which a first contact is situated, in addition to a diaphragm, spanning the recess, on which a second contact is situated. When a predetermined pressure threshold is exceeded, the two contacts come into contact with one another and form an electrical connection.

Both the diaphragm and the substrate are preferably made of a semiconductor material such as an epitaxial layer. The substrate and the diaphragm preferably are made of the same material.

The recess provided in the semiconductor substrate is preferably produced using a porous semiconductor technology, in particular por-Si technology. In a first step, doping is introduced into the semiconductor substrate, thereby producing a doped region (p-, for example) which in a second step is partially etched, resulting in a porous semiconductor structure. In a further process step, an epitaxial layer (mono- or polycrystalline) is produced on the semiconductor substrate, including the porous region; the epitaxial layer later forms the diaphragm for the pressure switch. Lastly, by suitable process control, in particular by the use of high temperatures, the porous region under the epitaxial layer is rearranged at the edge of the porous region (which is thereby liquefied). A portion of the porous region accumulates on the diaphragm and forms the first contact, and another portion accumulates at the bottom of the recess and forms the second contact.

Using such a production method, it is possible to produce a particularly economical, reliable, and precise pressure switch having a very compact design.

The base of the recess preferably has a projection, pointing in the direction of the diaphragm, on which projection the second contact is situated; when the diaphragm is deflected, the projection first comes into contact with the second contact or with the first contact. If needed, a depression on whose edge electrical contacts are situated which are electrically short-circuited when the diaphragm deflects may also be provided on the base of the recess. Below the pressure threshold of the switch, the contacts located on the base of the recess are electrically isolated from one another.

For laterally delimiting the recess, before the recess is produced, the semiconductor substrate is preferably provided with a second doping region which delimits the periphery of the recess.

The contact connections for the pressure switch according to the present invention are preferably situated on the epitaxial layer.

A micromechanical pressure change sensor according to the present invention is preferably produced from a semiconductor substrate, and has a diaphragm which is likewise made of semiconductor material. The pressure change sensor has a recess situated in the semiconductor substrate, in addition to a diaphragm that spans the recess. The pressure change sensor according to the present invention also has means for pressure compensation (for example, valves or channels having a defined flow characteristic) which connect the recess with the outside environment and allow pressure compensation between the pressure in the recess and the external pressure. When the pressure changes, the diaphragm is only temporarily pressed in, and afterwards returns to the rest position due to the pressure compensation between the recess and the outside environment.

The time constant for this process may be set by appropriate dimensioning of the means for pressure compensation. A pressure change sensor according to the present invention has the advantage that it is much less sensitive to high pressures than, for example, a pressure switch. In contrast to the pressure switch, on whose diaphragm the entire absolute pressure is exerted and which consequently undergoes more or less intense deflection, no pressure is exerted on the diaphragm of the pressure change sensor according to the present invention when the external pressure is static. It is thus possible to achieve high sensitivity that is independent of the absolute pressure.

The means for pressure compensation for the micromechanical pressure change sensor are preferably produced using porous semiconductor technology. In other words, by partial etching, a porous structure through which pressure compensation can occur is produced in the semiconductor material. The characteristic properties of the pressure change sensor are determined by the area and porosity (defined by current density, doping, and HF concentration in the production process) of the pressure compensation region.

Optionally, pressure compensation channels may also be provided in the semiconductor substrate or in the diaphragm.

The diaphragm is preferably formed from an epitaxial layer which is grown on the semiconductor substrate.

The deflection of the diaphragm, which is a measure of the prevailing pressure change, is preferably recorded by piezoresistive resistors which may be situated on or in the diaphragm. The piezoresistive resistors are connected to an electronic evaluation unit which, for example, displays the rate of pressure change. A capacitive or similar evaluation may also be performed.

To avoid contamination of the pressure compensation region (the porous region or the pressure compensation channels), the pressure change sensor may be protected by a housing which preferably has a diaphragm itself for media separation.

### BRIEF DESCRIPTION OF THE DRAWINGS

The present invention is explained in greater detail below, with reference to the accompanying drawing.

FIG. 1 shows a measuring system according to one embodiment of the present invention.

FIG. 2 shows a pressure sensor measuring system having multiple pressure sensors.

FIG. 3 shows a micromechanical pressure switch according to one embodiment of the present invention.

FIG. 4 shows the micromechanical pressure switch of FIG. 3 in the state of being acted on by pressure.

FIGS. 5a-5f show various process steps in the production of the pressure switch of FIG. 3.

FIGS. 6a, 6b show various process steps in the production of a pressure switch according to another embodiment of the present invention.

FIG. 7 shows a schematic illustration of a pressure change sensor.

FIG. 8 shows a cross-sectional view of a micromechanical pressure change sensor according to one embodiment of the present invention.

### DETAILED DESCRIPTION OF EXAMPLE EMBODIMENTS

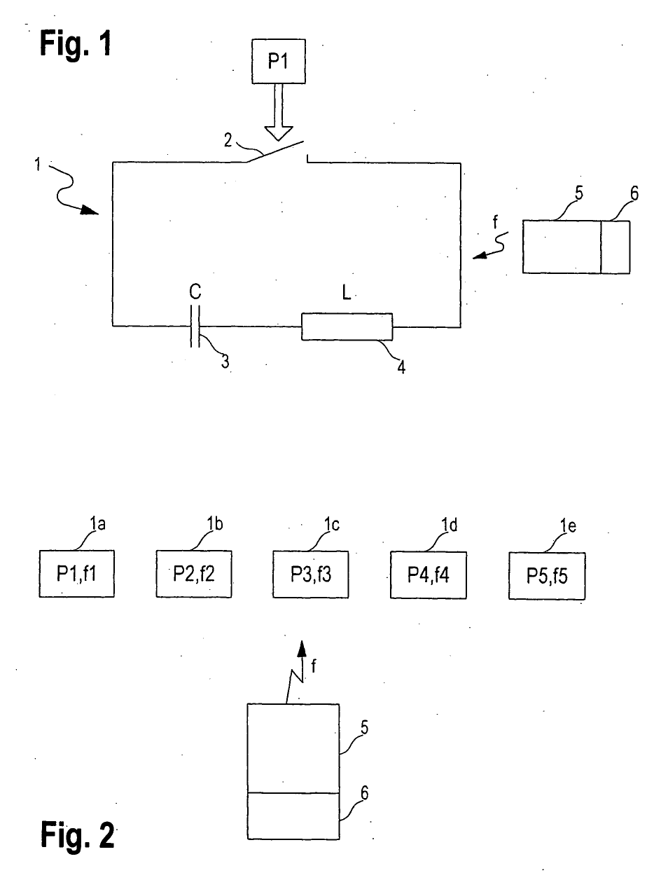

FIG. 1 shows a measuring system for the contactless pressure measurement of gas pressures, such as the tire pressure in a motor vehicle tire, for example. The illustrated pressure sensor measuring system includes a pressure sensor 1 which is situated in the motor vehicle tire, for example, in addition to an external (stationarily mounted) receiver 5 having an electronic evaluation unit 6.

Pressure sensor 1 includes a pressure switch 2, in particular a micromechanical pressure switch, to which an LC serial circuit composed of an inductor 4 and a capacitor C is connected. Pressure switch 2 opens or closes LC circuit 3, 4 as a function of the prevailing pressure. If the pressure is above switching threshold P1 for pressure switch 2, pressure switch 2 is switched on. For a pressure less than P1, the switch is switched off.

Pressure sensor 1 operates in a purely passive manner and does not require its own power supply, such as a battery, for example. For a measurement, pressure sensor 1 is excited by external transmitter 5, which is able to emit frequencies in the range of the resonant frequency of LC circuit 3, 4. When pressure switch 2 is closed (P>P1) and the sensor is excited at the resonant frequency, LC oscillating circuit 3, 4 comes into resonance, and in this state absorbs a considerably higher amount of transmitted energy than outside the resonance region. A pressure measurement may thus be carried out by evaluating the degree of absorption.

The resonant response of LC oscillating circuit 3, 4 may also be optionally evaluated. When it is in resonance, LC circuit 3, 4 emits the resonant frequency as well as harmonic waves, which are detectable by electronic evaluation unit 6 in transmitter 5. A particularly accurate and interference-free measurement may be achieved, for example, by using both evaluation methods.

Pressure Sensor Measuring System Having Multiple Pressure Sensors

FIG. 2 shows a pressure sensor measuring system having multiple pressure sensors 1a-1e according to FIG. 1, whose pressure switches 2 have different switching thresholds P1 and whose circuits have different resonant frequencies fi. In this case, transmitter 5 is able to emit frequencies between lowest resonant frequency f1 and highest resonant frequency f5, and to evaluate the resonant response or the degree of absorption of individual pressure sensors 1a-1e.

If the pressure is between pressures P3 and P4, for example, pressure switches 2 for pressure sensors 1a-1c are closed and pressure switches 2 for pressure sensors 1d, 1e are opened. For a measurement, therefore, only pressure sensors 1a-1c respond and come into resonance, but not pressure sensors 1d, 1e.

To avoid measuring errors due to external interference fields, which emit frequencies near a resonant frequency f1, pressure sensors 1a-1e may each have multiple pressure switches 2 with the same switching thresholds, but having LC circuits with different resonant frequencies. Thus, when the switching threshold is exceeded it is possible to determine several absorption maxima at different transmission frequencies. Since a possible source of interference usually emits interfering signals at only one frequency, the interference may be detected as such.

The Pressure Switch

FIG. 3 shows one embodiment of a micromechanical pressure switch which may be used for tire pressure measurement, for example. Pressure switch 10 is made of a doped semiconductor chip 12, and has a recess 14 that is covered by a diaphragm 13. The recess is peripherally delimited by an n+ doped region 15.

The base region of recess 14 has a contact 17. A second contact 16 is situated on diaphragm 13. As illustrated in FIG. 3, contacts 16, 17 are in the pressureless rest position, separated at a distance from one another.

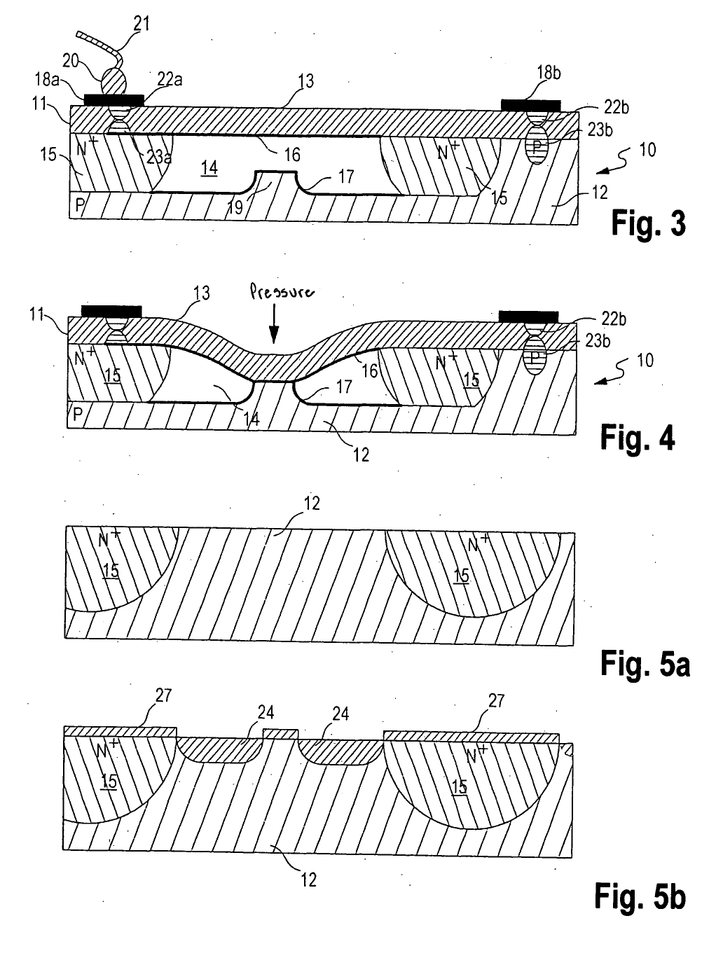

FIG. 4 shows the state of pressure switch 10 under the effect of pressure. In this state the diaphragm is deflected downward in such a way that contacts 16, 17 make contact and the electrical circuit is closed. The current is able to flow through pressure switch 10 via contact 18a, p-dopings 22a, 23a, contacts 16, 17, p-doped semiconductor substrate 12, p-dopings 22b, 23b, and contact 18b.

Production of a Pressure Switch

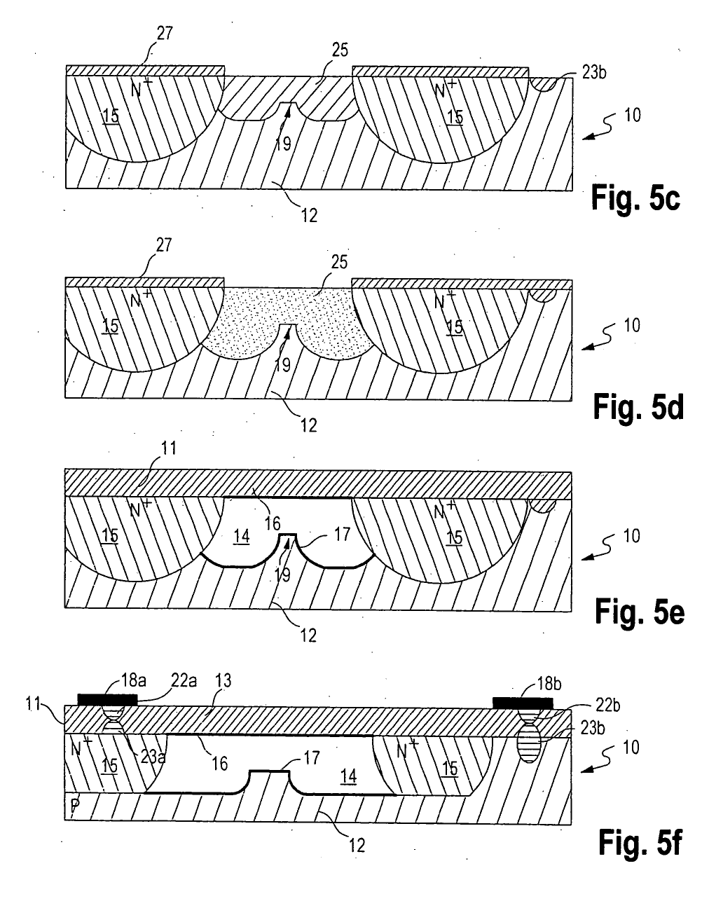

The process steps in the production of such a pressure switch 10 are explained by way of examples in FIGS. 5a-5e. FIG. 5a shows a sectional representation through a Si chip having two n⁺ doped regions 15 which form the peripheral boundary of recess 14, which is produced in a subsequent stage of the process. The n⁺ doped regions 15 are situated at a predetermined distance from one another.

FIG. 5b shows pressure switch 10 after a second process step in which a predetermined region is p⁺ doped between n⁺ regions 15. Reference number 27 designates a mask used in the lithography process. Doping regions 24 are preferably introduced into substrate 12 at high temperatures to obtain a deeper p⁺ doping.

FIG. 5c shows pressure switch 10 after a second p⁺ doping in which the entire region between n⁺ doping regions 15 is again p⁺ doped. Optionally, the p⁺ doping may be driven inward again at high temperatures. This results in a p⁺ doped region 25 which later forms recess 14. In addition, another p doped region 23b is produced which is used for contacting of pressure switch 10.

FIG. 5d shows a state of pressure switch 10 after a further process step in which a porous region 26 is produced by partial etching (also known as the por-Si process), using an etchant and applying a current.

In a subsequent process step the surface of semiconductor chip 12, including porous region 26, is provided with an epitaxial layer 11. Recess 14 is subsequently produced. Under the effect of high temperatures, porous region 26 begins to liquefy and accumulates on diaphragm 13 and on the base of recess 14. The accumulated material forms contacts 16 and 17, respectively. A projection 19 pointing in the direction of epitaxial layer 11 remains in the center of recess 14.

There is no accumulation or doping at lateral n⁺ doped regions 15, since the dopant concentration in n⁺ regions 15 preferably is significantly higher than that in p⁺ region 26.

FIG. 5e shows pressure switch 10 having recess 14 and contacts 16, 17.

FIG. 5f shows p⁺ doping regions 22a, 22b, which are provided for electrical contacting of pressure switch 10. p⁺ doping 23b is achieved by thermally driving p⁺ doping 23b, illustrated in FIG. 5b, into epitaxial layer 11. In addition, contacts 18a, 18b are applied to the surface of epitaxial layer 11 and contacted via bonding wires 20, 21.

The operating region and the sensitivity of pressure switch 10 are determined by the distance between n+ doped regions 15, the thickness of epitaxial layer 11, and the distance between contacts 16 and 17.

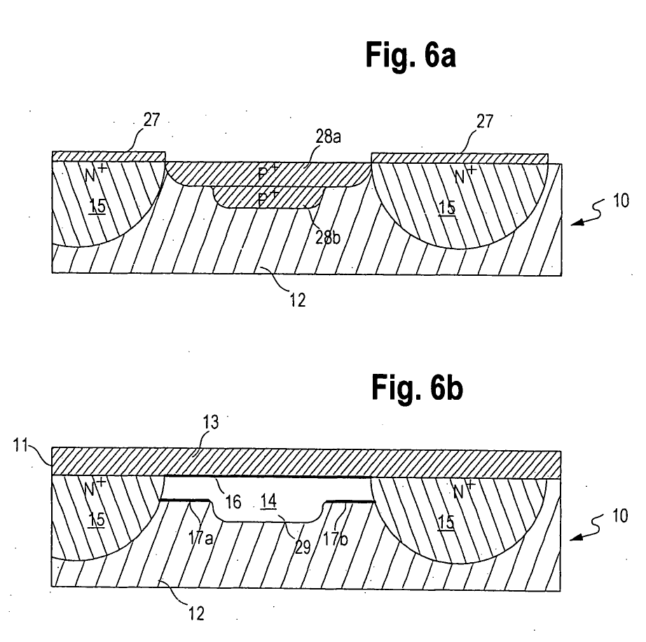

FIGS. 6a and 6b show two process stages of a pressure switch 10 in which, instead of projection 19, a depression 29 is provided at the base of recess 14. The individual process steps otherwise basically correspond to those of FIGS. 5a through 5f.

FIG. 6a shows pressure switch 10 after the production of differently sized doping regions 28a, 28b (both p⁺, for example) in substrate 12. In a porous semiconductor process using partial etching and high temperatures, these doping regions in turn are converted to recess 14 having a depression 29. The material in regions 28a and 28b accumulates again on epitaxial layer 11 or on the base of recess 14, respectively, and at those locations forms contacts 16 and 17a, 17b, respectively.

FIG. 6b shows a state of pressure switch 10 after recess 14 having depression 29 is produced. Contacts 17a, 17b, which in the illustrated rest state are electrically isolated from one another, are formed at the edge of depression 29. Under sufficiently high external pressure, diaphragm 13 deflects inward so that contact 16 present on the diaphragm electrically bridges contacts 17a, 17b. Contacts 17a, 17b must be externally contacted in a suitable manner (not shown).

The Pressure Change Sensor

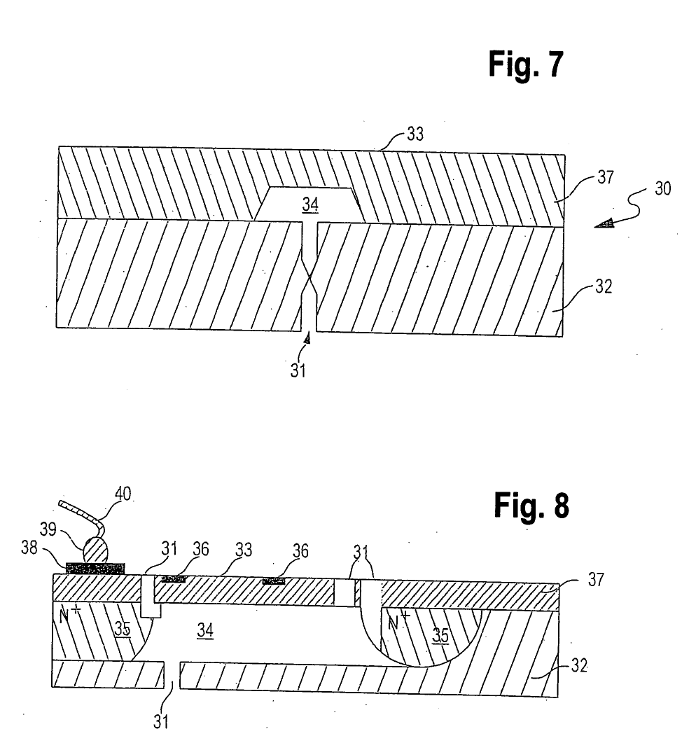

FIG. 7 shows a schematic illustration of a micromechanical pressure change sensor having a diaphragm 33. In this description, the term “pressure change sensor” is understood to mean a sensor using which it is possible to detect a change in pressure, independently of the absolute pressure.

Illustrated pressure change sensor 30 is composed of a semiconductor substrate 32 having a recess 34 which is covered by a diaphragm 33. Pressure change sensor 30 also has means for pressure compensation, such as, for example, a pressure compensation channel 31, which has a defined flow resistance and connects recess 34 to the outside environment.

At stationary pressure, diaphragm 33 is in the rest state (see FIG. 8). When the pressure drops, diaphragm 33 curves outward, and when the pressure rises the diaphragm curves inward. The deflection of diaphragm 33 is detected by suitable sensor elements 36, for example pieozresistive resistors, which are situated in or on the diaphragm. After a predetermined time the internal pressure in recess 34 equals the external pressure, and air or gas flows through channel 31, inward into cavity 34 or outward to the outside environment. Curved diaphragm 33 slowly returns to the rest position.

Recess 34 may be provided either in substrate 32 or, as shown, in a layer 37 situated on the substrate.

Since pressure change sensor 30 functions independently of the absolute pressure, and needs only to withstand changes in pressure, pressure change sensor 30 may have a relatively simple design.

FIG. 8 shows a cross section through one preferred embodiment of a pressure change sensor 30. Pressure change sensor 30 is composed of a semiconductor substrate 32 such as p-doped silicon, for example. A recess 34 is provided in semiconductor substrate 32 which is peripherally delimited by an n⁺-doped region 35. An epitaxial layer 37 applied to the surface of semiconductor substrate 32 simultaneously forms diaphragm 33 for pressure change sensor 30.

Epitaxial layer 37 is connected via contact 38, to which bonding wires 39, 40 are attached.

Recess 34 may be produced in a porous semiconductor process, for example, in which, by the use of a suitable etchant and application of current, first a porous region, for example a por-Si region, is produced, which in a subsequent process step is melted at high temperature and is rearranged.

For pressure compensation between recess 34 and the exterior, pressure compensation channels 31 are provided which may be situated in diaphragm 33 or in semiconductor substrate 32. Pressure compensation channels 31 may be produced in a por-Si process or in a conventional etching process, for example.

When the external pressure increases, diaphragm 33 curves inward into recess 34, and when the external pressure decreases the diaphragm curves outward. Due to channels 31, pressure compensation occurs between recess 34 and the exterior, and after a time period determined by the flow properties of channels 31, diaphragm 33 returns to the relaxed rest position. After this time has elapsed, the output signal from sensor element 36 will again assume the “zero value.”

To avoid contamination of pressure compensation channels 31, the sensor may be accommodated in a housing (not shown) which, for example, may have a diaphragm itself for media separation.

1. A pressure sensor for measuring a gas pressure, comprising:
a pressure switch which is switched on or off as a function of a prevailing pressure; and
a resonant circuit connected to the pressure sensor switch, the resonant circuit configured to be opened and closed by the pressure switch.

2. A measuring system for a contactless measurement of a gas pressure, comprising:
a pressure sensor including a pressure switch and a resonant circuit, the pressure switch being connected to the resonant circuit, the resonant circuit configured to be opened or closed as a function of a prevailing pressure; and
a transmitter separately situated relative to the pressure sensor, the transmitter configured to excite the resonant circuit in a contactless manner and to evaluate a degree of absorption or a resonant response of the pressure sensor.

3. A measuring system for a contactless measurement of a gas pressure, comprising:
a plurality of pressure sensors, each of the sensors including a pressure switch and a resonant circuit, the pressure switch being connected to the resonant circuit, the resonant circuit configured to be opened or closed as a function of the prevailing pressure; and
a transmitter separately situated relative to the sensors, the transmitter configured to excite the resonant circuits in a contactless manner and to evaluate a degree of absorption or a resonant response of the pressure senses;
wherein each of the switches have a different switching threshold, and each of the resonant circuits have a different resonant frequency.

4. A measuring system for a contactless measurement of a gas pressure, comprising:
a plurality of pressure sensors, each of the sensors including a pressure switch and a resonant circuit, the pressure switch being connected to the resonant circuit, the resonant circuit configured to be opened or closed as a function of the prevailing pressure; and
a transmitter separately situated relative to the sensors, the transmitter configured to excite the resonant circuits in a contactless manner and to evaluate a degree of absorption or a resonant response of the pressure senses;
wherein at least two of the switches have the same switching thresholds but different resonant frequencies.

5. A micromechanical pressure switch for measuring a gas pressure comprising:
a semiconductor substrate having a recess with a first contact; and
a diaphragm having a second contact, the diaphragm spanning the recess.

6. The micromechanical pressure switch as recited in claim 5, wherein both the substrate and the diaphragm are produced from a semiconductor material.

7. The micromechanical pressure switch as recited in claim 5, wherein the diaphragm is formed from an epitaxial layer.

8. The micromechanical pressure switch as recited in claim 5, wherein the semiconductor substrate has a projection in the region of the recess which points in a direction of the diaphragm and upon which the first contact is situated.

9. The micromechanical pressure switch as recited in claim 5, wherein the recess includes a depression.

10. The micromechanical pressure switch as recited in claim 5, wherein the recess is produced using a porous semiconductor technology.

11. A method for producing a micromechanical pressure switch from a semiconductor substrate, comprising:
introducing doping into the semiconductor substrate;
partially etching a doped region and producing a porous semiconductor region;
applying a layer to the semiconductor substrate, including the porous region, which forms a diaphragm for the pressure switch; and
rearranging the porous region by suitable process control so that a recess is formed, a portion of the porous region accumulating on the diaphragm and forming a first contact, and a portion of the porous region accumulating on the semiconductor substrate and forming a second contact.

12. The method as recited in claim 11, further comprising:
before the recess is produced, providing the semiconductor substrate with a second doping region which determines a peripheral extension of the recess in the semiconductor substrate.

13. The method as recited in claim 11, wherein the recess is produced using porous silicon technology.

14. The method as recited in claim 11, further comprising:
situating contact connections of the pressure switch on top of the layer.

15. The method as recited in claim 11, further comprising:
producing one of a projection pointing in the direction of the diaphragm, or a depression, in the recess.

16. A micromechanical pressure change sensor for measuring a gas pressure, comprising:
a semiconductor substrate having a recess;
a diaphragm which spans the recess; and
a pressure compensation arrangement via which the recess is connected to an outside environment.

17. The micromechanical pressure change sensor as recited in claim 16, wherein the recess in the semiconductor substrate is produced by porous etching.

18. The micromechanical pressure change sensor as recited in claim 16, wherein the arrangement for pressure compensation arrangement includes at least one pressure compensation channel formed in one of the semiconductor substrate or an epitaxial layer.

19. The micromechanical pressure change sensor as recited in claim 16, wherein the diaphragm is formed from an epitaxial layer.

20. The micromechanical pressure change sensor as recited in claim 16, wherein the pressure compensation arrangement is produced by partial etching, resulting in a porous region.

21. The micromechanical pressure change sensor as recited in claim 16, further comprising:
piezoresistive resistors provided on the diaphragm.

22. The micromechanical pressure change sensor as recited in claim 16, further comprising:
a projection pointing in a direction of the diaphragm and provided in the recess, the projection having a first contact, wherein a second contact is provided on an underside of the diaphragm which may be brought into contact with the first contact.
